(19) United States
(12) Patent Application Publication
(10) Pub. No.: US 2021/0129999 A1
(43) Pub. Date: May 6, 2021

(54) METHOD AND SYSTEM FOR DECELERATING AND REDIRECTING AN AIRBORNE PLATFORM

(71) Applicant: PARAZERO LTD., Kiryat Ono (IL)

(72) Inventor: Amir TSALIAH, Haifa (IL)

(21) Appl. No.: 16/492,327

(22) PCT Filed: Mar. 15, 2018
(86) PCT No.: PCT/IL2018/050303

§ 371 Date: Sep. 9, 2019

(30) Foreign Application Priority Data
Mar. 22, 2017 (IL) 251342

(51) Int. Cl. B64D 19/02; B64C 39/02; G05D 1/10

(52) U.S. Cl. CPC B64D 19/02; B64C 39/024; B64C 2201/185; B64C 2201/027; B64C 2201/108; G05D 1/106

(57) ABSTRACT

The present invention provides a method for decelerating and redirecting an airborne platform, comprising the steps of retaining a flexible airfoil in non-deployed form in controllably releasable secured relation with each corresponding rotor arm of a multi-rotor drone; and upon detecting rate of descent of said drone in a first direction to be greater than a predetermined value, triggering release of one or more of said retained airfoils from said corresponding rotor arm and causing each of said released airfoils to be circumferentially displaced from a first rotor arm to a second rotor arm of said drone to occlude an adjacent inter-arm region, wherein each of said circumferentially displaced airfoils generates a sufficient value of localized lift that causes said descending drone to change its direction of descent from said first direction to a second direction.

### FIELD OF THE INVENTION

The present invention relates to the field of multi-rotor aircraft, such as unmanned aerial vehicles (UAVs) and drones. More particularly, the invention relates to a method and system for decelerating and redirecting a platform of such aircraft.

### BACKGROUND OF THE INVENTION

The use of drones and other types of multi-rotor aircraft has been steadily increasing in recent years, particularly for performance of autonomous missions such as pollution detection, aerial photography, and surveillance. At some times, due to the autonomous or semi-autonomous nature of the missions, an unforeseen collision occurs with the drone or the drone unexpectedly malfunctions, resulting in a rapid descent because of the inability of the drone to generate sufficient lift.

Some drones are equipped with an automatic parachute deployment system to decelerate the rapid descent of drones during such extenuating circumstances. However, these prior art parachute deployment systems merely decelerate the rate of fall, but do not control the direction of descent. There is therefore a significant risk that a plunging drone will collide with an underlying structure such as a building or a mountain, leading to irreparable and costly damage to the drone.

Also, the parachute size and weight of prior art drones is limited, and consequently the deceleration that is achievable thereby is also limited.

It is an object of the present invention to provide a multi-rotor aircraft with a decelerating system that is capable of controlling the direction of descent of the aircraft.

Other objects and advantages of the invention will become apparent as the description proceeds.

### SUMMARY OF THE INVENTION

The present invention provides a method for decelerating and redirecting an airborne platform, comprising the steps of retaining a flexible airfoil in non-deployed form in controllably releasable secured relation with each corresponding rotor arm of a multi-rotor drone; and upon detecting rate of descent of said drone in a first direction to be greater than a predetermined value, triggering release of one or more of said retained airfoils from said corresponding rotor arm and causing each of said released airfoils to be circumferentially displaced from a first rotor arm to a second rotor arm of said drone to occlude an adjacent inter-arm region, wherein each of said circumferentially displaced airfoils generates a sufficient value of localized lift that causes said descending drone to change its direction of descent from said first direction to a second direction.

The release of the one or more retained airfoils from the corresponding rotor arm may be triggered in response to detection of an underlying obstacle. All of the one or more retained airfoils may be released from the corresponding rotor arm to ensure continued descent in the first direction if an obstacle is not found within a predetermined distance of a present location of the drone.

The present invention is also directed to a decelerating system for use in conjunction with a multi-rotor drone, comprising a plurality of airfoils; a airfoil retainer for maintaining each of said airfoils in non-deployed form with respect to a corresponding rotor arm of said drone; a securing element for controllably and releasably securing said airfoil retainer to a corresponding rotor arm; and a rotary ejector for rotating about a longitudinal axis of said drone and for thereby circumferentially displacing one or more of said airfoils, after being released from said retainer, from a first rotor arm to a second rotor arm of said drone to occlude an adjacent inter-arm region.

In other embodiments, the decelerating system may further comprise any one of the following components:
A. one or more sensors for detecting predetermined rapid descent of the drone and a safety-ensuring processing unit in data communication with said one or more sensors, with the rotary ejector, and with each of the airfoil retainer securing elements, wherein a triggering signal to cause circumferential displacement of the one or more of the airfoils is transmitted from said safety-ensuring processing unit to said ejector and to those securing elements corresponding to the one or more airfoils in response to detection of said predetermined rapid descent;
B. a corresponding interface element in data communication with the safety-ensuring processing unit that is controllably extendible from the ejector to each of the airfoils, wherein engagement of an extended interface element with an airfoil portion causes the corresponding airfoil to be circumferentially displaced to occlude the adjacent inter-arm region during rotation of the ejector;
C. a downwardly facing collision avoidance system in data communication with the safety-ensuring processing unit for transmitting a detection signal to the safety-ensuring processing unit upon detecting an obstacle along an uncorrected descent path in a first direction of the drone, wherein the safety-ensuring processing unit is operable to calculate a required direction of descent in order to avoid said obstacle and to cause a sufficient number of the airfoils, following transmission of the triggering signals, to become circumferentially displaced, each of said circumferentially displaced airfoils generates a sufficient value of localized lift that causes said descending drone to change its direction of descent from said first direction to a second direction which is suitable to avoid said obstacle; and D. planform adjusting means for each airfoil that is responsive to the transmission of the triggering signal and to the circumferential displacement of the one or more airfoils.

In one aspect, the safety-ensuring processing unit is an onboard computer.

### BRIEF DESCRIPTION OF THE DRAWINGS

In the drawings:

FIG. 1 is a schematic plan view of a multi-rotor drone according to one embodiment of the invention, illustrating selected inter-arm regions being occluded by corresponding circumferentially displaced airfoils;

FIG. 2 is a schematic plan view of the drone of FIG. 1, the airfoils thereof shown in a fully deployed condition;

FIG. 3 is a schematic plan view of the drone of FIG. 1, two airfoils thereof shown in a fully deployed condition to cause the drone to rotate about the pitch axis;

FIG. 4 is a schematic plan view of the drone of FIG. 1, two airfoils thereof shown in a fully deployed condition to cause the drone to rotate about the roll axis;

FIG. 5 is a schematic plan view of the drone of FIG. 1, two airfoils thereof shown in a fully deployed condition to cause the drone to hover; and

FIG. 6 is a schematic illustration of a deceleration system according to one embodiment of the invention.

### DETAILED DESCRIPTION OF PREFERRED EMBODIMENTS

A drone is configured with many sophisticated systems to support semi-autonomous missions performable by remote control or even fully autonomous missions, including a propulsion system, communication system, control system, collision avoidance system and power system. The loss of the drone is imminent upon failure of any one of these systems.

To minimize damage to the drone as a result of a system failure and to nearby structures following a drone caused collision, a safety-ensuring processing unit embodied by the onboard drone computer or a dedicated remote computer activates a decelerating system upon detection of rapid descent of the drone, for example after surpassing a predetermined threshold, to decelerate the rate of descent. The rotor based propulsion system, if employed, is automatically deactivated to prevent damage to the decelerating system.

During decelerating system assisted descent, the drone is subjected to wind drifts and the influence of gravity, and is therefore directed along an uncontrollable path until landing, or unfortunately colliding with a structure located along its path.

In order to avoid a collision between a drone and a structure during decelerating system assisted descent, the decelerating system of the present invention in conjunction with the safety-ensuring processing unit is capable of controlling the direction of descent of the drone.

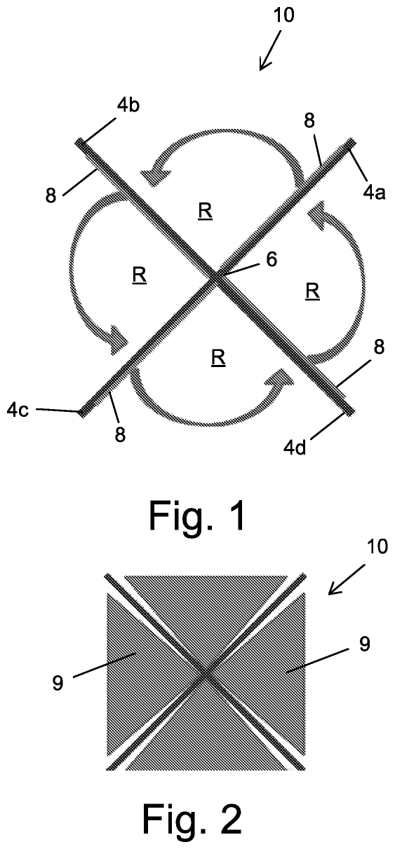

As shown in FIG. 1, the type of drone that is suitable for the present invention is the multi-rotor type wherein a rotor is carried by the radial outward end, or a portion proximate to the end, of each corresponding rotor arm. Each rotor is independently rotatable and controllable to achieve a desired resultant drone thrust and a desired resultant drone moment.

The schematically illustrated multi-rotor drone 10 is shown to have four rotor arms 4a-d that extends radially outwardly from a central hub 6, or from any other central region of convergence, to define a normally unobstructed inter-arm region R by two adjacent rotor arms 4. It will be appreciated that the invention is similarly applicable to a drone having any other number of rotor arms.

As opposed to prior art parachute deployment systems that comprise a single parachute for the entire drone, the deployment system of the present invention comprises a plurality of airfoils, one for each rotor arm. Following generation of a triggering signal by the safety-ensuring processing unit in response to detection of predetermined rapid descent of the drone, one or more airfoils are forcibly circumferentially displaced in the same rotational direction, from one rotor arm 4 to another, in order to occlude the adjacent inter-arm region R. Following occlusion of each selected inter-arm region R, the occluding airfoil becomes expanded to generate lift and to thereby decelerate the rate of descent of the drone.

An airfoil retainer 8 for maintaining an airfoil in compact, non-deployed form is provided with each rotor arm 4. The airfoil is preferably, but not necessarily, made of flexible and lightweight nonporous material. Airfoil retainer 8 may be embodied by a canister that has one opening facing an adjacent inter-arm region R and one or more elements for controllably and releasably securing the airfoil to a closed wall of the canister. In one embodiment, airfoil retainer 8 comprises one or more attachment elements for controllably and releasably securing the airfoil externally to a corresponding rotor arm 4.

By employing a plurality of independently displaceable airfoils, the rate and direction of lift may be advantageously controlled. When all airfoils 9 are deployed as shown in FIG. 2, the combined lift is vertically directed and the descending drone 10 proceeds along its downward path in a substantially vertical direction, albeit at a slower rate, which is influenced only by sideward wind drifts. However when one or more of the airfoils 9 are not deployed, the drone ceases to become balanced and changes its direction of descent in order to avoid, for example, an underlying structure that is liable to afflict significant damage to the drone or to bystanders upon collision with the drone.

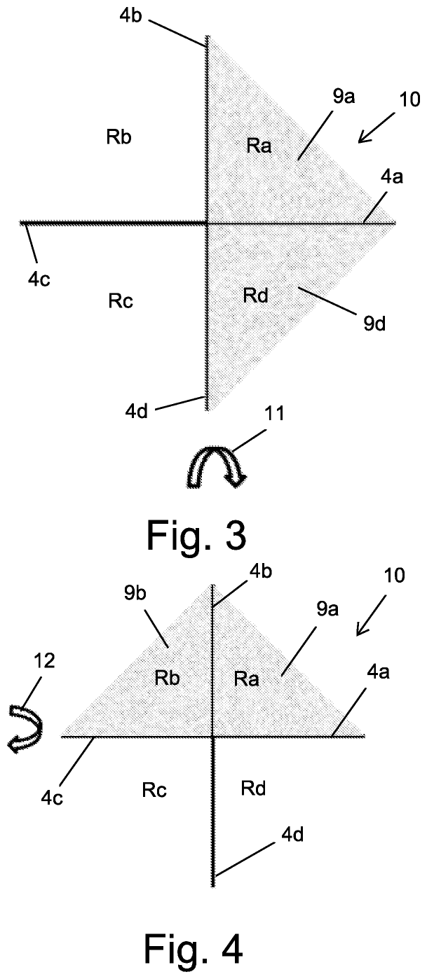

For example, as shown in FIG. 3, drone 10 is caused to rotate in the direction indicated by arrow 11 about the pitch axis defined by rotor arms 4b and 4d when airfoils 9a and 9d are deployed to occlude regions Rₐ and R_{d}, respectively, due to the increased lift localized at regions Rₐ and R_{d} relative to the diametrically opposite regions R_{b} and R_{d}. Thus in combination with the downward pull of gravity, drone 10 will be forced to undergo a leftward movement in accordance with the illustrated orientation.

Alternatively, as shown in FIG. 4, drone 10 is caused to rotate in the direction indicated by arrow 12 about the roll axis defined by rotor arms 4a and 4c when airfoils 9a and 9b are deployed to occlude regions Rₐ and R_{b}, respectively, due to the increased lift localized at regions Rₐ and R_{b} relative to the diametrically opposite regions R_{c} and R_{d}. Thus in combination with the downward pull of gravity, drone 10 will be forced to undergo a rightward movement in accordance with the illustrated orientation.

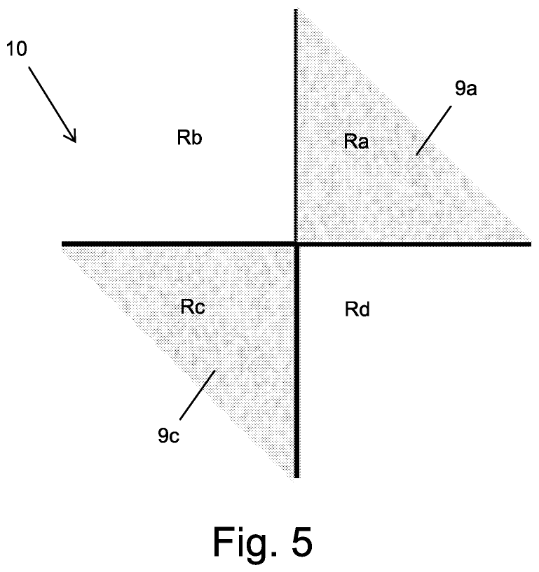

In another scenario illustrated in FIG. 5, drone 10 is allowed to hover when diagonally opposite airfoils 9a and 9c are deployed to occlude regions Rₐ and R_{c}, respectively, as a result of the angularly balanced lift localized thereat which counteracts the downward pull of gravity.

The speed of descent is greatly influenced by the surface area of the airfoil perpendicular to the downward direction and by the weight carrying capacity of the drone.

When drone 10 is configured to hover as illustrated, it may be urged to be slightly redirected in a desired direction by selectively adjusting the planform, i.e. projected area of an airfoil, when viewed from above. Since lift is directly proportional to the airfoil planform area, the lift acting on a given airfoil may be controlled by adjusting the planform, for example by inflating or deflating the airfoil or by repositioning a portion of the airfoil, such as the angle of the radially inward tip of the airfoil with respect to the horizontal plane. Thus drone 10 will be caused to be redirected by adjusting the difference in lift acting on two different airfoils. The direction to which drone 10 is redirected may be more accurately controlled when all airfoils are deployed, and the planform of each airfoil is different.

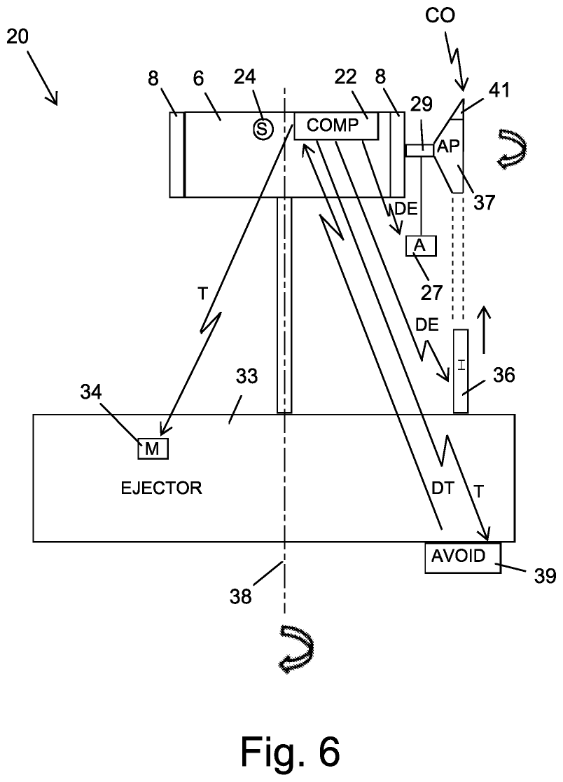

FIG. 6 schematically illustrates a deceleration system 20 according to one embodiment of the invention. Deceleration system 20 comprises onboard computer 22 for coordinating transmission of the control signals, one or more sensors 24 in data communication with computer 22 for detecting predetermined rapid descent of the drone, and an actuator 27 in data communication with onboard computer 22 for a releasable airfoil retainer securing element 29. Computer 22 transmits a signal, whether a wired or wireless signal, to each selected actuator 27 following detection of the predetermined rapid descent of the drone, to initiate release of a corresponding securing element 29 from its airfoil retainer 8.

Deceleration system 20 may also comprise a rotary airfoil ejector 33 that is located below, and possibly connected to, the convergence region 6 of the rotor arms, a retractable interface element 36 that is controllably extendible from ejector 33 to a corresponding airfoil portion (AP) 37, and a controllable coupling element 41. A downwardly facing collision avoidance system 39 is also in data communication with computer 22.

In operation, a triggering signal T is transmitted simultaneously to the motor 34 of ejector 33 that generates the rotary motion and to collision avoidance system 39. If collision avoidance system 39 detects an obstacle located along the uncorrected descent path of the drone, for example within a predetermined distance, a detection signal DT is transmitted to computer 22, and the latter calculates in response the direction of descent that is needed in order to avoid the detected obstacle. The rate of circumferential displacement of airfoil portion 37 may be increased if an obstacle is in relatively close proximity. If an obstacle has not been detected, all airfoils are simultaneously deployed so that the combined lift will be vertically directed and the drone will continue its downward descent.

After computer 22 computes the required direction of descent, it transmits a deployment signal DE simultaneously to the actuator 27 of airfoil retainer securing element 29 and to the interface element 36 associated with those selected airfoils that are needed to be deployed in order to generate the necessary directional lift for ensuring the required direction of descent. Extension of a selected interface element 36 is synchronized to be carried out at a time slightly following release of the corresponding securing element 29. The extended interface element 36 is adapted to become engaged with a corresponding airfoil portion 37 adjacent to the released securing element 29, for example by means of dedicated engagement elements that may be actuated.

Since ejector 33 has been caused to rotate at a predetermined rate about its central axis 38 and the extended interface element 36 has become engaged with a corresponding airfoil portion 37, airfoil portion 37 is forced to be circumferentially displaced from a first rotor arm with which airfoil retainer 8 has been provided, in order to occlude the adjacent inter-arm region. At the end of the circumferential displacement of the airfoil, airfoil-connected coupling element 41 is actuated following transmission of a coupling signal CO and is then secured to the second rotor arm to enable the lift generating capabilities of the airfoil.

Deceleration system 20 may be sufficiently quick reacting so as to generate lift by deploying a selected number of airfoils and thereby correcting the direction of descent within 0.3 sec, or any other suitable period of time, after detection of the underlying obstacle.

Deceleration system 20 may also comprise planform adjusting means for each airfoil that is responsive to triggering signal T.

It will be appreciated that the airfoils may be deployed in response to a remotely controlled action which is controlled by a dedicated remote computer constituting the safety-ensuring processing unit, to coordinate transmission of the control signals and to cause one or more of the airfoils to be circumferentially displaced or planform-adjusted in response to detection of an underlying obstacle.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A method for decelerating and redirecting an airborne platform, comprising the steps of:
a) retaining a flexible airfoil in non-deployed form in controllably releasable secured relation with each corresponding rotor arm of a multi-rotor drone; and
b) upon detecting rate of descent of said drone in a first direction to be greater than a predetermined value, triggering release of one or more of said retained airfoils from said corresponding rotor arm and causing each of said released airfoils to be circumferentially displaced from a first rotor arm to a second rotor arm of said drone to occlude an adjacent inter-arm region,
wherein each of said circumferentially displaced airfoils generates a sufficient value of localized lift that causes said descending drone to change its direction of descent from said first direction to a second direction.

2. The method according to claim 1, wherein release of the one or more retained airfoils from the corresponding rotor arm is triggered in response to detection of an underlying obstacle.

3. The method according to claim 1, wherein all of the one or more retained airfoils are released from the corresponding rotor arm to ensure continued descent in the first direction if an obstacle is not found within a predetermined distance of a present location of the drone.

4. The method according to claim 1, further comprising the step of adjusting a planform of one or more airfoils that has occluded an adjacent inter-arm region.

5. A decelerating system for use in conjunction with a multi-rotor drone, comprising:
a) a plurality of airfoils;
b) an airfoil retainer for maintaining each of said airfoils in non-deployed form with respect to a corresponding rotor arm of said drone;
c) a securing element for controllably and releasably securing said airfoil retainer to a corresponding rotor arm; and
d) a rotary ejector for rotating about a longitudinal axis of said drone and for thereby circumferentially displacing one or more of said airfoils, after being released from said retainer, from a first rotor arm to a second rotor arm of said drone to occlude an adjacent inter-arm region.

6. The decelerating system according to claim 5, further comprising one or more sensors for detecting predetermined rapid descent of the drone and a safety-ensuring processing unit in data communication with said one or more sensors, with the rotary ejector, and with each of the airfoil retainer securing elements,
wherein a triggering signal to cause circumferential displacement of the one or more of the airfoils is transmitted from said safety-ensuring processing unit to said ejector and to those securing elements corresponding to the one or more airfoils in response to detection of said predetermined rapid descent.

7. The decelerating system according to claim 6, further comprising a corresponding interface element in data communication with the safety-ensuring processing unit that is controllably extendible from the ejector to each of the airfoils, wherein engagement of an extended interface element with an airfoil portion causes the corresponding airfoil to be circumferentially displaced to occlude the adjacent inter-arm region during rotation of the ejector.

8. The decelerating system according to claim 7, further comprising a downwardly facing collision avoidance system in data communication with the safety-ensuring processing unit for transmitting a detection signal to the safety-ensuring processing unit upon detecting an obstacle along an uncorrected descent path in a first direction of the drone,
wherein the safety-ensuring processing unit is operable to calculate a required direction of descent in order to avoid said obstacle and to cause a sufficient number of the airfoils, following transmission of the triggering signals, to become circumferentially displaced, each of said circumferentially displaced airfoils generates a sufficient value of localized lift that causes said descending drone to change its direction of descent from said first direction to a second direction which is suitable to avoid said obstacle.

9. The decelerating system according to claim 6, wherein the safety-ensuring processing unit is an onboard computer.

10. The decelerating system according to claim 6, further comprising planform adjusting means for each airfoil that is responsive to the transmission of the triggering signal and to the circumferential displacement of the one or more airfoils.
